(19) United States
(12) Patent Application Publication
(10) Pub. No.: US 2026/0370551 A1
(43) Pub. Date: Nov. 19, 2026

(54) SYSTEMS AND METHODS FOR CONFIGURING COMPONENTS OF A PROTECTED NETWORK TO LIMIT FORMAT DRIFT DURING EXECUTION OF THE COMPONENTS OF THE PROTECTED NETWORK

(71) Applicant: Capital One Services, LLC, McLean, VA (US)

(72) Inventors: Berkcan KAPUSUZOGLU, McLean, VA (US); Supriyo CHAKRABORTY, McLean, VA (US)

(73) Assignee: Capital One Services, LLC, McLean, VA (US)

(21) Appl. No.: 19/207,273

(22) Filed: May 13, 2025

(51) Int. Cl. H04L 41/0823; H04L 41/147; H04L 41/16

(52) U.S. Cl. CPC H04L 41/0836; H04L 41/147; H04L 41/16

(57) ABSTRACT

Systems and methods are described herein that can involve obtaining a set of strings associated with a context and processing the set of strings using a predictive model. The predictive model can be configured using a teacher model that is configured to generate both target outputs and critiques about the operations performed by the predictive model. Examples can include critiques of operations that result in format drift, as represented by the output of the predictive model in response to receiving training inputs.

### BACKGROUND

Network monitoring systems can implement predictive systems to monitor for network operations that are associated with malicious activity. For example, these predictive models can be tuned by repeatedly adjusting the predictive system's internal settings so that the outputs produced align as closely as possible with known examples, such as indications of malicious or non-malicious configurations. But despite these predictive systems'abilities to generate outputs that closely resemble these target outputs, they often rely on statistical patterns learned from training data to map inputs to outputs without constructing or evaluating the intermediate reasoning steps that would underpin a genuine understanding of the corresponding input. As a result, these systems cannot justify their conclusions through transparent chains of thought and, in some cases, can be susceptible to adversarial or manipulation attacks.

### SUMMARY

In view of these challenges, systems and methods are described herein relating to novel uses and/or improvements to components of a protected network that limit format drift during execution of the components of the protected network, such as predictive models used to analyze network operations executed in the network. By integrating techniques that blend both the imitation of target outputs and critique signals during training, a predictive model's internal reasoning steps become more robust and less susceptible to manipulation by malicious parties. These methods enhance the model's capacity to truly understand and generate outputs based on underlying logic rather than just mimicking surface-level patterns, thereby reducing the risk of adversarial exploitation that might target predictable or brittle reasoning pathways. By enforcing consistency through example-aligned formatting and using critique signals to refine outputs, the system ensures that even if an attacker attempts to introduce misleading inputs or perturbations, the predictive model's reasoning remains anchored in verified, high-integrity logic. This layered approach not only fortifies the model against direct format drift but also shields its decision-making process, making it considerably harder for adversaries to successfully cause the execution of network operations that exploit vulnerabilities in its reasoning chain, potentially wasting significant computing and memory resources (e.g., where the network operations are involved in, for example, attacks aimed at wasting computing resources).

In some examples, the systems and methods described can be configured to avoid format drift to address the issue of blind imitation inherent in conventional supervised fine-tuning (SFT) techniques. In conventional models, SFT often leads to a mere replication of correct outputs without a deep internalization of the underlying reasoning, which limits the model's capacity to generalize beyond its training data. This can result in repeated modification of the input and execution of the model in an attempt to obtain a suitable output, wasting computing resources in the process. By contrast, the systems and methods described herein can implement techniques that configure the predictive models described to analyze and infer the reasoning behind each output. This approach can lead to a nuanced analysis of the inputs provided to the predictive models, allowing them to generate outputs that more closely approximate the corresponding target outputs while also more closely reflecting the intent and logic underlying the training data. Further, the predictive models configured as described herein can maintain similar performance despite reduced parameter sizes when compared to larger parameter (“teacher”) models. This can allow for further reduced processor and memory consumption at inference time while maintaining model performance abilities (including the ability to forgo drift and/or resist attacks).

Another benefit of the systems and methods trained as described herein is their improved ability to reduce high refinement uncertainty. In many post-training scenarios, a predictive model's output space can exhibit high entropy, meaning that the outputs vary considerably and lack consistency. To address this, conventional models can be increased in size (e.g., parameter count) and trained on extensive training datasets. The predictive models described herein mitigate this issue by integrating critique signals during training, which helps guide the predictive model's configuration process. These signals act as feedback that anchor the lower-parameter predictive model's outputs toward more deterministic and well-defined responses, thereby lowering the entropy and ensuring that the predictions are consistently reliable and aligned with the intended format and reasoning.

To achieve these benefits, systems and methods can be implemented as described herein configuring components of a protected network to limit format drift during execution of the components of the protected network. For example, a system can include one or more processors configured to perform one or more operations. The one or more operations can include obtaining a set of strings representing a context as based on interactions involving a user interface. The operations can also include providing the set of strings as an input to a predictive model configured to perform one or more context-based operations and one or more analysis-based operations based on the set of strings. This can cause the predictive model to generate an output indicating a response to the context that satisfies a predetermined format associated with the context based on providing the data packet as the input to the predictive model. As described herein, the predictive model can be trained by obtaining target outputs and critiques based on outputs of the predictive model, the target outputs generated by a predetermined predictive model (e.g., a teacher model) based on predetermined formats, and executing one or more configuration operations. These configuration operations can be to reconfigure the predictive model based on the target outputs and the critiques to cause the predictive model to generate the outputs similar to the target outputs that are based on the predetermined formats and reduce a probability that the predictive model will incorporate a format drift into the outputs.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows a diagram of an environment for configuring components of a protected network to limit format drift during execution of the components of the protected network, in accordance with one or more embodiments.

FIG. 2 shows a diagram of a process for configuring components of a protected network to limit format drift during execution of the components of the protected network, in accordance with one or more embodiments.

FIG. 3 shows components for a system used to configure components of a protected network to limit format drift during execution of the components of the protected network, in accordance with one or more embodiments.

FIG. 4 shows a flowchart of the steps involved in a process for configuring components of a protected network to limit format drift during execution of the components of the protected network, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

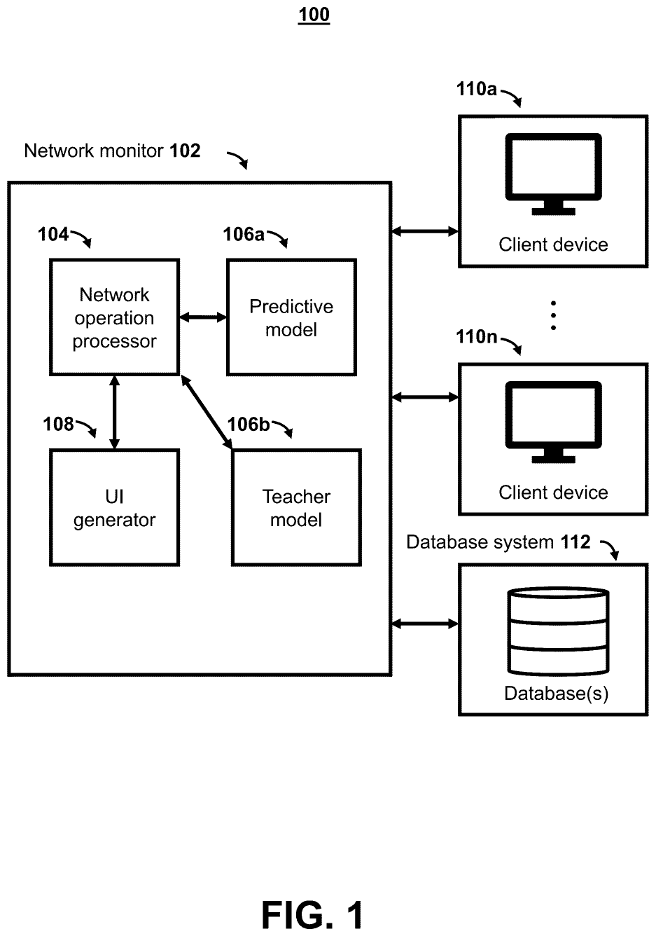

FIG. 1 shows a diagram of an environment 100 that can, among other things, be used to configure components of a protected network to limit format drift during execution of the components of the protected network, in accordance with one or more embodiments. For example, the environment 100 can include a network monitor 102 having one or more components as described herein, a set of client devices 110 (referred to individually as a client device 110 and collectively as client devices 110, where contextually appropriate), and a database system 112. The network monitor 102 (e.g., one or more components of the network monitor 102), the client devices 110, the and/or the database system 112 can be configured to interconnect using one or more wired and/or wireless communication connections. As will be understood, the environment 100 includes a network monitor 102, the client devices 110, the and/or the database system 112, but similar environments can include more devices that are the same as, or similar to, those described.

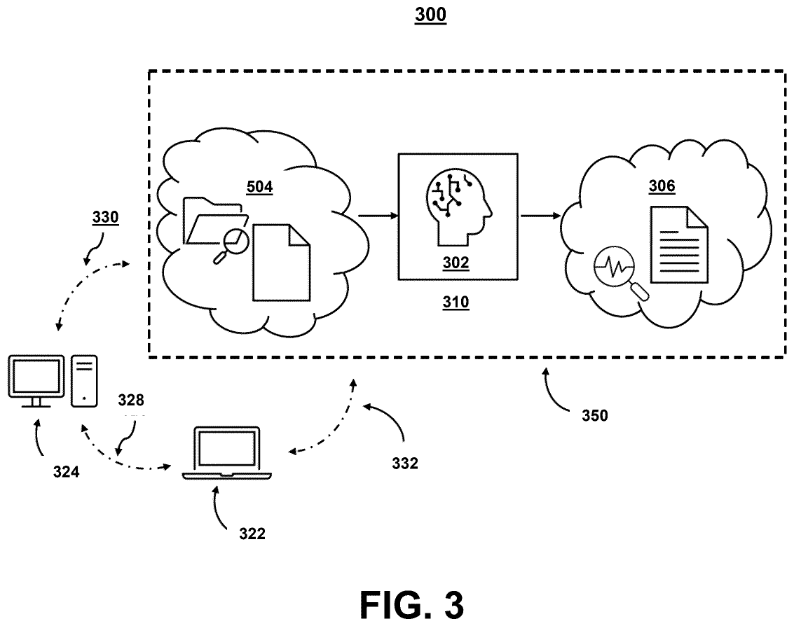

In some embodiments, the network monitor 102 can include a computing device that is configured to be in communication with the client devices 110, the and/or the database system 112 using one or more communication paths (also referred to as communication connections) as described herein. For example, the network monitor 102 can include a desktop computer, a laptop computer, a smartphone, a tablet, and/or the like. In some embodiments, the network monitor 102 can include (e.g., implement) a network operation processor 104, a predictive model 106a, and/or a user interface (UI) generator 108. While certain components are illustrated by FIG. 1, the network monitor 102 can include and/or exclude one or more of the illustrated components. The network monitor 102 can also include one or more components that are the same as, or similar to, the user terminal 324 of FIG. 3. As described herein, the network monitor 102 (e.g., one or more components of the network monitor 102) can establish one or more secured or unsecured communication connections with the client devices 110 and/or the database system 112. In some embodiments, the network monitor 102 can be implemented by an organization such as a financial institution monitoring a network involved in processing network operations as described herein.

In some embodiments, the client devices 110 can include a computing device that is configured to be in communication with the network monitor 102 using one or more communication connections as described herein. For example, the client devices 110 can include a desktop computer, a laptop computer, a smartphone, a tablet, and/or the like. As described herein, the client devices 110 can establish one or more secured or unsecured communication connections with the network monitor 102 or with one or more components monitored by the network monitor 102, such as a protected network.

In some embodiments, the database system 112 can include a computing device that is configured to be in communication with the network monitor 102 using one or more communication connections as described herein. For example, the database system 112 can include a desktop computer, a laptop computer, a smartphone, a tablet, and/or the like. In some embodiments, the database system 112 can include (e.g., implement) a database that maintains training datasets used to train and/or update the predictive model 106a. For example, the database system 112 can be configured to store input sets of strings, reasoning tokens, and output sets of strings to use when training and/or updating the predictive model 106a as described below. These input sets of strings, reasoning tokens and/or outputs sets of strings (target outputs) can be generated by the teacher model 106b as described herein.

In some embodiments, the network operation processor 104 can be associated with instructions executable by the network monitor 102. For example, the network operation processor 104 can be implemented as instructions that configure one or more components of the network monitor 102 (e.g., processor(s), memory, etc.) to perform one or more operations when analyzing network operations as described below. The network operation processor 104 can additionally, or alternatively, be implemented as instructions that configure one or more components of the network processor (e.g., the predictive model 106a, the teacher model 106b, etc.) to process these network operations.

In some embodiments, the predictive model 106a can be associated with instructions executable by the network monitor 102. For example, the predictive model 106a can be implemented as instructions that configure one or more components of the network monitor 102 (e.g., processor(s), memory, etc.) to perform one or more operations when analyzing network operations as described below. In some embodiments, the predictive model 106a can be implemented as a variety of neural network architectures configured to ingest string-based data and emit corresponding response strings. For example, the predictive model 106a can include an attention-based model architecture (e.g., a transformer, etc.) that can be deployed to model long-range relationships between words in the strings of text (represented as tokens). The predictive model 106a can also be implemented as an ensemble in which multiple independently trained neural networks vote or blend their logits to generate the sets of strings as described herein.

At inference, the predictive model 106a can receive an input associated with a set of strings, where each string can represent natural language sentences, command sequences, or domain-specific tokens. The predictive model 106a can tokenize the sets of strings to generate embeddings (e.g., numerical tensors that form the input layer activations of model 106a). The predictive model 106a can then execute one or more operations in accordance with the architecture of the predictive model 106a through a forward pass and cause the terminal layer to generate an output representing a set of strings corresponding to predicted next sentences, completions, or reasoned answers.

The predictive model 106a can be configured (e.g., trained) by the network monitor 102 (e.g., based on execution of the network operation processor 104 or another system) providing the predictive model 106a to with training inputs including of an input set of strings and response sets of strings (target outputs) maintained in the database system 112. These target outputs can be generated by the teacher model 106b. During each forward pass, the predictive model 106a can determine a predicted distribution over possible output tokens, and the network operation processor 104 can determine a difference (also referred to as a “loss”) such as cross-entropy between the output of the predictive model 106a and the output of the teacher model 106b. The network operation processor 104 can then update the predictive model 106a to reduce this loss in subsequent executions of the predictive model 106a (implementing backpropagation techniques, etc.). The cycle of presenting input-output pairs, calculating loss, propagating gradients, and updating weights repeats across multiple epochs until convergence criteria are met, at which point the model can generalize to unseen string inputs and generate contextually relevant response strings in deployment.

In some embodiments, the teacher model 106b can be associated with instructions executable by the network monitor 102. For example, the teacher model 106b can be implemented as instructions that configure one or more components of the network monitor 102 (e.g., processor(s), memory, etc.) to perform one or more operations when training the predictive model 106a to analyze network operations as described below. In certain embodiments, the teacher model 106b can have an architecture that is the same or similar to the predictive model 106a (e.g., a multi-layer neural network, a transformer model, etc.), thereby providing comparable representational capacity. In some examples, the teacher model 106b can differ from the predictive model 106a in that it can include a larger number of parameters and can be trained on a broader and more diverse dataset. During training, the teacher model 106b can distill its learned information such as soft class probabilities, intermediate feature representations, or attention maps into the predictive model 106a through the generation of target outputs and critiques, enhancing the accuracy of the predictive model 106a.

In some embodiments, the UI generator 108 can be associated with instructions executable by the network monitor 102. For example, the UI generator 108 can be implemented as instructions that configure one or more components of the network monitor 102 (e.g., processor(s), memory, etc.) to perform one or more operations to generate user interfaces to be displayed on client devices 110 as described herein. The UI generator 108 can then establish communication connections with the client devices 110 involved in the execution of one or more network operations to cause a user interface to be displayed thereon. These client devices 110 can either be controlled by individuals who initiated the network operations or individuals monitoring the protected network to ensure safe network operation.

While certain components are illustrated by FIG. 1, the environment 100, or the various devices thereof, can include and/or exclude one or more of the illustrated components. The environment 100 can also include one or more components that are the same as, or similar to, the devices of FIG. 3. In some embodiments, the devices of the environment 100 can be configured to establish direct or indirect communication connections between one another. For example, one or more networks can establish communication paths between one or more of the devices of the environment 100 to allow for the communication of messages (e.g., data packets/network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein. It will also be understood that the number and arrangement of devices in the environment 100 are provided as an example and that there can be differently arranged environments than those shown in FIG. 1. In some embodiments, at least some of the device(s) and/or system(s) of FIG. 1 can be implemented by a single device or multiple devices within a distributed system. For example, the network monitor 102 can be implemented by a single device or as multiple devices that, either alone or in coordination, perform one or more of the operations as described herein.

With continued reference to FIG. 1, one or more of the components can be configured to execute operations that allow for the implementation of the predictive model 106a when performing one or more operations (e.g., monitoring for malicious activity, responding to user requests, etc.) and limit format drift during execution thereof. In examples described herein, a network operation is described as being associated with and/or representing a request to process mathematical inputs associated with, for example, information related to payment transactions, such as loans, loan attributes, and the reasoning behind determining one or more additional attributes (e.g., whether to permit or not permit continued processing of the loan. However, it will be understood that the principles described herein are not limited to these types of network operations.

In some embodiments, a network monitor 102 can obtain a data packet that includes (or otherwise represents) a set of strings. For example, the network monitor 102 can obtain the data packet from a client device 110 in response to input received at the client device 110 from a user. The input can be associated with a network operation processed by a network overseen by the network monitor 102 and can include or represent a context as described herein. Additionally, the network monitor 102 can timestamp the data packet and assign a session identifier that allows later correlation with other data packets in the same workflow. Based on receiving the data packet, the network monitor 102 can coordinate execution of one or more components, such as the network operation processor 104 and/or the predictive model 106a, as described below to process the network operation and generate a response. In some embodiments, the network operations can that correspond to requests to cause the network operation processor 104 to analyze mathematical queries through combinations of attention and chain-of-thought reasoning.

In some embodiments, the network monitor 102 can obtain an encrypted version of the data packet from the client device 110. For example, the client device 110 can encrypt the data packet using a session key negotiated during a transport layer security (TLS) handshake with the network monitor 102. After obtaining the encrypted version of the data packet, the network monitor 102 can decrypt the data packet by applying a corresponding decryption key retrieved from a secure key store maintained by the network monitor (e.g., in a secure key store, etc.). In at least some examples, the network monitor 102 can determine to provide the decrypted data packet (e.g., the set of strings associated with the network operation) to a predictive model 106a as an input based on decrypting the data packet. This can include, for example, analyzing the data packet (once decrypted) to identify the predictive model 106a from among a plurality of predictive models (not illustrated for clarity) configured to process sets of strings corresponding to varying types of network operations and/or contexts.

In some embodiments, the network operation processor 104 can provide the set of strings representing a context as an input to the predictive model 106a. For example, the network operation processor 104 can provide the set of strings as an input to the predictive model 106a, where the predictive model 106a is configured to perform one or more context-based operations and/or analysis-based operations. For example, the network operation processor 104 can forward the set of strings over an inter-process communication channel to the predictive model 106a. This can cause the predictive model 106a to execute a forward pass in accordance with the input and generate an output (e.g., a set of strings that are based on, and responsive to, the input). As discussed, context-based operations can refer to the attention-driven computations of a transformer-based neural networks that build contextual embeddings by weighting relationships among the tokens in the input strings. Similarly, analysis-based operations can refer to the reasoning steps of a retrieval-augmented generation (RAG) model that first retrieves external knowledge (e.g., from databases, websites, etc.) and then performs multi-step logical inference over the retrieved content together with the set of strings provided as input.

In some examples, the context can correspond to or otherwise indicate information represented by the set of strings being processed by the network monitor 102. For example, the context can include algebraic problem statements, symbolic representations of differential equations, logical propositions expressed in a structured query language, etc. In some example, the set of strings from the input can encode a sequence of mathematical steps, such as variable substitutions, simplifications, or factorization operations that are configured to guide the predictive model 106a toward a result. While aspects of the present disclosure are described with respect to mathematics-based contexts, it will be understood that a variety of contexts can be associated with the sets of strings processed by the predictive model 106a. For example, the contexts can be associated with network security alerts indicating one or more aspects of one or more network operations being processed by the network (where the network operations may be involved in malicious activity), natural-language conversation logs indicating one or more aspects of dialog sessions between users and automated agents (where the users may similarly be involved in malicious activity), etc.

In some embodiments, the network operation processor 104 can determine a set of tokens corresponding to the set of strings. For example, the network operation processor 104 can determine a set of tokens corresponding to the set of strings that denote, for example, coefficients, exponents, or matrix dimensions to be analyzed by the predictive model 106a. The network operation processor 104 can annotate each token with positional metadata (e.g., positional embeddings) that identify the token's role in an inference chain to allow the predictive model 106a to align generated reasoning tokens (corresponding to reasoning steps) with the structure of the string of text. In examples, the context can also include metadata flags indicating aspects about the format according to which the predictive model 106a should generate an output set of strings.

In some embodiments, the network operation processor 104 can segment the set of strings into a plurality of tokens (discussed above) that form a token sequence representing the context when providing the set of strings as the input to the predictive model 106a. For example, the network operation processor 104 can execute a tokenizer module that splits the set of strings based on character boundaries, delimiter symbols, or semantic units. In some examples, the tokenizer module can prepend a start-of-sequence token and append an end-of-sequence token to the plurality of tokens. In at least some examples, the network operation processor 104 can supply the plurality of tokens to the predictive model 106a through a shared memory buffer (not explicitly illustrated) that preserves token ordering. The network operation processor 104 can then cause the network operation processor 106 to be executed in accordance with the plurality of tokens as described below.

In some embodiments, the network operation processor 104 can generate an embedding corresponding to the plurality of tokens based on a mapping between the plurality of tokens and the token sequence when providing the plurality of tokens as the input to the predictive model 106a. The network operation processor 104 can then determine to provide the embedding as the input to the predictive model 106a based on (e.g., in response to) generating the embedding. For example, the network operation processor 104 can determine that the embedding is compatible with the predictive model 106a based on the types of training inputs and target outputs involved in training and/or updating the predictive model 106a. Where the predictive model 106a is compatible with the embedding (e.g., with the type of the input to the predictive model 106a (e.g., mathematical formulas, logic statements, etc.) matches the types of the training inputs and target outputs), the network operation processor 104 can execute the predictive model 106a in accordance with the embedding.

In some embodiments, the network operation processor 104 can cause the predictive model 106a to generate an output indicating a response that is based on the context. For example, the network operation processor 104 can cause the predictive model 106a to generate the response including a set of strings responsive to the set of strings input to the predictive model 106a (represented as the embedding discussed above). In this example, the predictive model 106a can be configured to generate responses such that the responses satisfy a predetermined format associated with the context. For example, the output can include a set of strings corresponding to a format type that indicates one or more of bullet-point hierarchies, indenting conventions, tab alignment, and uniform variable-type usage (e.g., integers, floats, arrays, etc.). The predetermined format can correspond to a format according to which the predictive model 106a is configured to generate outputs. Additionally, or alternatively, the predetermined format can correspond to a format established by the set of strings being processed. As described herein, the predictive model 106a can be configured (e.g., trained) such that format drift (e.g., misplaced bullets, inconsistent indentation, errant tab spacing, variable-type mismatches, etc.) is reduced or eliminated.

In some embodiments, the network operation processor 104 can cause the UI generator 108 to generate a user interface to be displayed on the client device 110 that received the input corresponding to the set of strings. For example, the network operation processor 104 can cause the UI generator 108 to generate user interface data associated with a user interface. In this example, the user interface data can be configured to cause a display device of the client device 110 to render the response using the predetermined format so that bullet points, indenting, tabs, and variable-type annotations are consistent with preestablished formatting conventions according to which the predictive model 106a is configured to operate. In some example, the user interface can highlight any tokens that were adjusted by the predictive model 106a to reduce or eliminate the ability of the predictive model to incorporate a format drift, allowing an individual to review an output that is aligned between the original context and the generated response.

In some embodiments, the predictive model 106a can be trained using training data packets that include training inputs, target outputs and critiques generated at least in part by predetermined predictive model (illustrated and described as a teacher model 106b). For example, the predictive model 106a (also referred to as a “student model” during training) can be trained using target outputs that include strings of text responsive to input strings of text (e.g., training inputs). Additionally, the predictive model 106a can be trained based on critiques generated by a predetermined predictive model (teacher model 106b) and/or training outputs generated by the teacher model 106b that are conditioned on these critiques. These critiques can indicate issues, variations, or improvements that could be made to either the reasoning steps executed by the predictive model 106a and/or the outputs of the predictive model 106a, as discussed below. These training inputs, training outputs, and critiques can be stored in the database system 112 as training data packets.

In some embodiments, the target outputs can be generated by the teacher model 106b based on predetermined formats (also referred to as training formats) according to which the teacher model 106b is configured. Additionally, or alternatively, the teacher model 106b can be configured to generate the target outputs in accordance with predetermined formats that are represented by the training input (as recognized by the teacher model 106b) . In these examples, the teacher model 106b can be executed to generate target outputs to be used by the network monitor 102 (e.g., the network operation processor 104, etc.) when implementing one or more configuration operations to reconfigure the predictive model 106a. These configuration operations can cause the predictive model 106a to be iteratively updated to generate outputs similar to the target outputs in the predetermined formats. For example, the teacher model 106b (e.g., a large language model frozen at an evaluation baseline) can generate target outputs that represent a response to the training input that satisfies a desired formatting standard.

In some embodiments, the network operation processor 104 can obtain the target outputs and the critiques based on execution of the teacher model 106b that, in response to obtaining the outputs of the predictive model 106a (also referred to as training outputs during the training process), generates the critiques to identify at least one deficiency in the outputs or reasoning of the predictive model 106a. These critiques can include indications of mismatches between the reasoning tokens, ordering discrepancies, and format differences between the training formats represented by the outputs of the predictive model 106a during training and the predetermined formats discussed herein. These critiques can highlight differences between the outputs generated by the predictive model 106a (the training outputs) and the target outputs generated by the teacher model 106b.

In some embodiments, the network operation processor 104 can execute the teacher model 106b to generate the target outputs based on the critiques, the predetermined formats, and/or corresponding training inputs. Based on these outputs, the network operation processor 104 can determine to execute the one or more configuration operations based on the target outputs and the critiques. For example, the teacher model 106b can compare the outputs and reasoning tokens generated by the predictive model 106a with the target output and/or reasoning tokens generated by the teacher model 106b when evaluating the same training input, and generate critiques that target specific aspects of the operation of the predictive model 106a that led to mismatches between the output of the predictive model 106a and the predetermined formats expected by the teacher model 106b. In some examples, the teacher model 106b can synthesize a corrected version of each output that complies with the predetermined formats to serve as the target outputs, and the network operation processor 104 can log the critiques and the target outputs for use when updating aspects of the predictive model 106a (e.g., weights of the predictive model 106a, etc.).

In some embodiments, the network operation processor 104 can determine the target outputs and update the predictive model 106a based on executing the teacher model 106b in accordance with a set of sub-routines (e.g., a first sub-routine, a second sub-routine, etc.). For example, to cause the teacher model 106b to generate the critiques based on training inputs and the target outputs, the network operation processor 104 can execute the first sub-routine. This first sub-routine can involve executing the teacher model 106b an in accordance with an evaluation prompt that causes the teacher model 106b to score the output generated by the predictive model 106a and the reasoning steps taken by the predictive model 106a when generating the output. This score can indicate a degree of adherence to a predetermined format, a degree to which the output matches the target output, a degree to which the reasoning tokens generated by the predictive model 106a match the reasoning tokens expected to be generated by the predictive model 106a, etc. The network operation processor 104 can also execute a second sub-routine to generate the target outputs. For example, the network operation processor 104 can execute the teacher model 106b to cause the teacher model 106b to generate the training outputs produced by the predictive model 106a that are conditioned on the critiques. This can result in the teacher model 106b rewriting the output generated by the student model in response to receiving the training input. In this way, the teacher model 106b can generate the target outputs using the critiques as conditioning information to maintain consistency between the reasoning steps and outputs generated by the predictive model 106a and allow for quicker convergence.

To generate the target outputs, the network operation processor 104 can generate conditioning inputs comprising the training outputs and the critiques using the teacher model 106b. When doing so, the network operation processor 104 can provide the conditioning inputs to the teacher model 106b as an input along with the training input and/or the output of the predictive model 106a to cause the teacher model 106b to generate the target outputs. For example, the conditioning inputs can be concatenated into a single token sequence tagged with segment identifiers that distinguish the training outputs from the critiques. The network operation processor 104 can also tag the critiques to indicate the reasoning steps identified by the critiques to be addressed during the next execution of the training input. In some examples, the teacher model 106b can apply cross-attention between the segment identifiers to fuse stylistic guidance from the critiques with semantic content from the training outputs.

In some embodiments, the network operation processor 104 can execute the one or more configuration operations by providing the training inputs to the predictive model 106a to cause the predictive model 106a to generate training outputs and determining differences between the training outputs and the target outputs. The network operation processor 104 can then execute the one or more configuration operations based on determining a result of a joint loss function that applies penalties based on the differences between the training outputs and the target outputs (conditioned on the critiques as auxiliary inputs). For example, the joint loss function can include a cross-entropy term that measures token-level divergence and a structural penalty term that measures deviation from a hierarchy defined by the predetermined formats and/or the deviations between the reasoning tokens expected vs. those actually generated by the predictive model 106a. The network operation processor 104 can then update the weights of the predictive model (e.g., through backpropagation, etc.) based on the output from the joint loss function to update parameters inside the predictive model 106a.

During training, the network operation processor 104 can determine that a difference between the training outputs and the target outputs satisfies a difference threshold indicating convergence of the predictive model 106a. These differences can represent differences in sets of tokens (e.g., amounts of consecutive tokens that match between the training output and the target output), format differences (e.g., the number of deviations between the format of the training output and the target output), and so on. In these instances, when a threshold number of training outputs are generated and indicate convergence, the network operation processor 104 can determine to forgo the execution of the one or more configuration operations (e.g., terminate training). For example, when a number of format differences satisfies a format difference threshold, the network operation processor 104 can determine to forgo execution of the one or more configuration operations. The network operation processor 104 can then cause the predictive model 106a to be implemented as an inference engine after the convergence determination.

As discussed above, during configuration, the network operation processor 104 can provide training inputs (e.g., training data packets) to the predictive model 106a to cause the predictive model 106a to generate training outputs. These training outputs can have training formats that are at least in part different from predetermined formats. For example, the network operation processor 104 can provide the training inputs to the predictive model 106a during successive training epochs. In some examples, training inputs can cause the predictive model 106a to generate training outputs that have formats that are at least in part different (e.g., mismatched) with the formats of the target outputs. The network operation processor 104 can then determine format differences between the training formats and the predetermined formats. For example, the network operation processor 104 can tokenize the training outputs to extract syntactic structures, semantic tags, or field delimiters that characterize the training formats. In some examples, the network operation processor 104 can compare the syntactic structures, semantic tags, or field delimiters with format descriptors that are similar and represent the predetermined formats. In this example, the network operation processor 104 can execute one or more operations to reduce or eliminate these format differences.

In some embodiments, the network operation processor 104 can execute one or more configuration operations based on the format differences. This can include adjusting one or more weights of the predictive model 106a to improve the formatting accuracy of the predictive model 106a when approximating the formatting accuracy of the teacher model 106b. In some examples, the network operation processor 104 can execute additional training cycles that apply the adjusted hyperparameters until updated format differences satisfy a convergence threshold. In this example, the convergence threshold can correspond to a predefined maximum number of acceptable mismatches per output token.

In some embodiments, the network operation processor 104 can determine that at least one format difference from the format differences satisfies a format difference threshold indicating convergence of the predictive model. For example, the network operation processor 104 can identify a number of format differences in the output of the predictive model 106a when compared to a threshold number represented by the format difference threshold. In some examples, the format difference threshold can be specified as a relative percentage of mismatched characters or tokens in the training outputs. In cases where the format differences satisfy the format difference threshold, the network operation processor 104 can determine to forgo execution of the one or more configuration operations.

As noted above, the network operation processor 104 can cause the predictive model 106a to process a set of strings associated with a context that corresponds to a mathematical query. In doing so, the network operation processor 104 can cause the predictive model 106a to generate training outputs based on training inputs associated with the mathematical query. For example, the training inputs can encode algebraic word problems that align with the target outputs representing correct solutions. In some examples, the predictive model 106a can produce the training outputs while maintaining an internal computation graph that maps each step of symbolic reasoning. In some embodiments, the network operation processor 104 can segment the training outputs into sets of sub-outputs to determine that the training outputs include step-by-step derivations, one or more symbolic equations expressed in mathematical markup, and a final numeric or algebraic solution. For example, the network operation processor 104 can apply expression boundaries, semantic parse trees, or markup tokenization to segment each training output into the sets of sub-outputs. In some examples, the sets of sub-outputs can be labeled as derivation steps, intermediate equations, and final solutions. The network operation processor 104 can then determine to execute the one or more configuration operations based on differences between the sets of sub-outputs and the target outputs. For example, the network operation processor 104 can identify missing derivation steps or incorrectly formatted symbolic equations within the sets of sub-outputs and map those discrepancies to the portions of the predictive model 106a that generated the discrepancies. In some examples, the network operation processor 104 can adjust these portions of the predictive model 106a to reduce the number of discrepancies upon subsequent execution

In some embodiments, the network operation processor 104 can determine that portions of the training outputs are missing from the sets of sub-outputs. For example, the network operation processor 104 can detect an absence of one or more expected derivation steps or expected symbolic equations within a given segmented set of sub-outputs. The detected absence can be incorporated into the critique to cause the network operation processor 104 to update the weights of the predictive model 106a during subsequent configuration. The network operation processor 104 can then determine to execute the one or more configuration operations based on the portions of the training outputs that are missing from the sets of sub-outputs.

In some embodiments, the network operation processor 104 can cause the predictive model to generate sets of intermediate outputs when generating the training outputs based on the training inputs corresponding to the target outputs. For example, the network operation processor 104 can cause the predictive model 106a to expose hidden-layer activations, attention weights, or intermediate textual tokens as the sets of intermediate outputs. In some examples, the network operation processor 104 can store the sets of intermediate outputs in an auxiliary data store for downstream analysis. For example, the network operation processor 104 can determine that one or more intermediate outputs (e.g., reasoning tokens, etc.) from the sets of intermediate outputs are logically inconsistent. In doing so, the network operation processor 104 can detect that an intermediate symbolic equation violates algebraic rules or that an attention-weight distribution conflicts with a previously generated derivation step. In some examples, the network operation processor 104 can compute inconsistency scores that quantify the extent of each logical inconsistency.

In some embodiments, the network operation processor 104 can determine to execute the one or more configuration operations based on determining that the one or more intermediate outputs (e.g., represented as reasoning tokens, etc.) are logically inconsistent. For example, the network operation processor 104 can adjust the predictive model by adding regularization terms that penalize logically inconsistent intermediate outputs or by fine-tuning specific layers responsible for the inconsistencies. In some examples, the network operation processor 104 can iterate through additional training epochs until updated logic-consistency evaluations indicate an acceptable level of consistency across the sets of intermediate outputs.

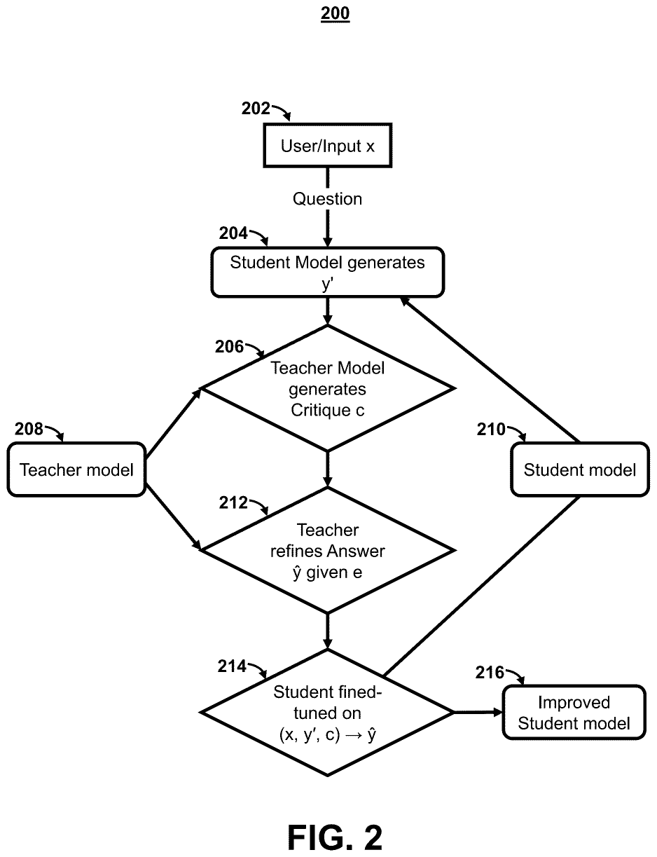

FIG. 2 shows a diagram of a process 200 for configuring components of a protected network to limit format drift during execution of the components of the protected network, in accordance with one or more embodiments. In some embodiments, one or more of the operations illustrated by the process 200 can be implemented using an environment (e.g., that is the same as, or similar to, the environment 100 of FIG. 1). For example, one or more of the operations illustrated by the process 200 can be implemented using a network component (e.g., that is the same as, or similar to, the network monitor 102 of FIG. 1). Additionally, or alternatively, one or more of the operations illustrated by the process 200 can be implemented by a device that is different from the network component, such as, for example, a client device (e.g., that is the same as, or similar to, the client device 110 of FIG. 1.

At 202, the process 200 can involve the network monitor receiving an inbound data packet from the client device. The data packet can represent a user input “X” that can be represented using a set of strings of text. The network monitor 102 can decrypt the data packet it if it was delivered over TLS, time-stamping it, tagging it with a session identifier, and recognizing the included set of strings as the contextual prompt (for example, a mathematical query or a loan-risk request) to be processed using a predictive model 210 (e.g., that is the same as, or similar to, the predictive model 106a). As an example, the set of strings can include a query “What is the oxidation state of Carbon in the compound Sodium Oxalate (#Na_2C_2O_4 #)” (representing the ionic salt Na₂C₂O₄).

At 204, the process 200 can involve a network operation processor tokenizing the strings, appending positional metadata, creating an embedding, and forwarding that embedding to the predictive model 210. The predictive model 210 (e.g., as a student model) can execute a forward pass and generate an initial answer y′ together with any reasoning tokens. The initial answer y′ may suffer from format drift or logical gaps. As an example, the initial answer y′ can include “The oxidation state of Carbon in Sodium Oxalate (#Na_2C_2O_4 #) is +3. Here's the step-by-step calculation: 1. The oxidation state of Sodium (Na) is +1. 2. The oxidation state of Oxygen (O) is −2. 3. The compound has 2 Sodium atoms, so the total oxidation state of Sodium is 2*(+1)=+2. 4. The compound has 4 Oxygen atoms, so the total oxidation state of Oxygen is 4*(−2)=−8. 5. The compound has 2 Carbon atoms, and let's denote the oxidation state of Carbon as x. So, the total oxidation state of Carbon is 2*x=2×. 6. The sum of the oxidation states of all atoms in the compound must be equal to the charge of the compound, which is 0 (since it's a neutral compound). Therefore, we can set up the equation: +2−8+2×=0. 7. Solving the equation for x, we get: 2×=6, and x=3. So, the oxidation state of Carbon in Sodium Oxalate (#Na_2C_2O_4 #) is +3.”).

At 206, the process 200 can involve executing a first sub-routine in which the teacher model 208 evaluates y′ against the predetermined formatting and reasoning standards, producing a structured critique c that pinpoints bullet misalignment, indentation errors, missing derivation steps, or other discrepancies. The critique can include “The student's solution is mostly correct in terms of the steps taken to calculate the oxidation state of Carbon in Sodium Oxalate (#Na_2C_2O_4 #). However, there is a mistake in the final calculation. The correct calculation should be: Given that the sum of the oxidation states of all atoms in the compound equals the charge of the compound (which is 0 for a neutral compound), the equation is set up correctly as +2 (from Sodium)−8 (from Oxygen)+2×(from Carbon)=0. Solving for x: +2−8+2×=0−6+2×=0 2×=6×=3 The mistake lies in the interpretation of the result. The calculation x=3 is correct, but this value represents the oxidation state of one Carbon atom. Since the question asks for the oxidation state of Carbon (implying a single atom's state within the compound), the calculation is correct, but the explanation could be clearer regarding the implication of the calculation for the oxidation state of Carbon in the context of the compound's structure. However, the critical point missed here is considering the structure of oxalate and how it influences the oxidation state of Carbon. In Sodium Oxalate, the oxalate ion is (#C_2O_4\hat{ }{2−}#), and when calculating the oxidation state of Carbon, one should consider the overall charge of the oxalate ion and how it distributes over the two Carbon atoms. The correct approach to finding the oxidation state of Carbon involves understanding that the two Carbon atoms are equivalent due to the symmetry of the oxalate ion. Conclusion: wrong”). Optionally, the teacher model 208 can also generate a quality score.

At 212, the process 200 can involve executing a second sub-routine in which the teacher model 208 consumes the triplet (input x, student answer y′, critique c) and rewrites y′ into a corrected target answer y\hat{ } that fully complies with the required format and rectifies the logical flaws identified in the critique. This can include “To find the oxidation state of Carbon in Sodium Oxalate (#Na_2C_2O_4 #), we follow these steps: 1. Identify the oxidation states of Sodium (Na) and Oxygen (O) as +1and −2, respectively. 2. Calculate the total oxidation state of Sodium: 2*(+1)=+2. 3. Calculate the total oxidation state of Oxygen: 4*(−2)=−8. 4. Recognize that the compound is neutral, so the sum of all oxidation states equals 0. 5. Set up the equation for the sum of oxidation states: +2 (from Sodium)−8 (from Oxygen)+2×(from the two Carbon atoms)=0, where x is the oxidation state of one Carbon atom. 6. Solve for x: −6+2×=0 2×=6×=3 This calculation confirms that the oxidation state of each Carbon atom in Sodium Oxalate is +3. It's essential to understand that this result is consistent with the structure of the oxalate ion, where both Carbon atoms are in equivalent environments and thus have the same oxidation state. The oxalate ion has a charge of −2, which is balanced by the +2 charge from the two Sodium ions, making the overall compound neutral. In the context of the oxalate ion (#C_2O_4\hat{ }{2−}#), considering the two Carbon atoms are equivalent and the ion has a −2 charge, we can also reason that since Oxygen's total contribution is −8, and the ion's charge is −2, the two Carbon atoms together must contribute +6 to the ion's charge to balance it, leading to each Carbon having an oxidation state of +3. This reasoning aligns with the mathematical calculation provided.”

At 214, the process 200 can involve computing a joint loss between the output of the student model y′ and the teacher's target y\hat{ }, incorporating token-level cross-entropy, structural penalties for formatting divergence, and optional regularization for logic-consistency, and then back-propagating that loss to fine-tune the weights of the student model (referred to as the improved student model 216). This training loop (the operations of process 200) can be repeated until the measured format differences and inconsistency scores fall below convergence thresholds.

FIG. 3 shows illustrative components for a system used to configure components of a protected network to limit format drift during execution of the components of the protected network, in accordance with one or more embodiments. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 can alternatively be any computing device as described above and can include any type of mobile terminal, fixed terminal, or other device. For example, cloud components 310 can be implemented as a cloud computing system and can feature one or more component devices. It should also be noted that system 300 is not limited to three devices. Users can, for instance, utilize one or more devices to interact with one another, one or more servers, or other components of system 300. It should be noted that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays and can instead receive and display content using another device (e.g., a dedicated display device such as a computer screen and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storage. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communications networks or combinations of communications networks. Communication paths 328, 330, and 332 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, an artificial intelligence model, etc. (which can be referred to collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem-solving as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, backpropagation techniques can be utilized by model 302, where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) cannot perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively, or additionally, the API layer 350 can reside on one or more of the cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications is in place.

In some embodiments, the system architecture can use a microservice approach. Such systems can use two types of layers: Front-End Layer and Back-End Layer, where microservices reside. In this kind of architecture, the role of the API layer 350 can provide integration between the Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as a standard for external integration.

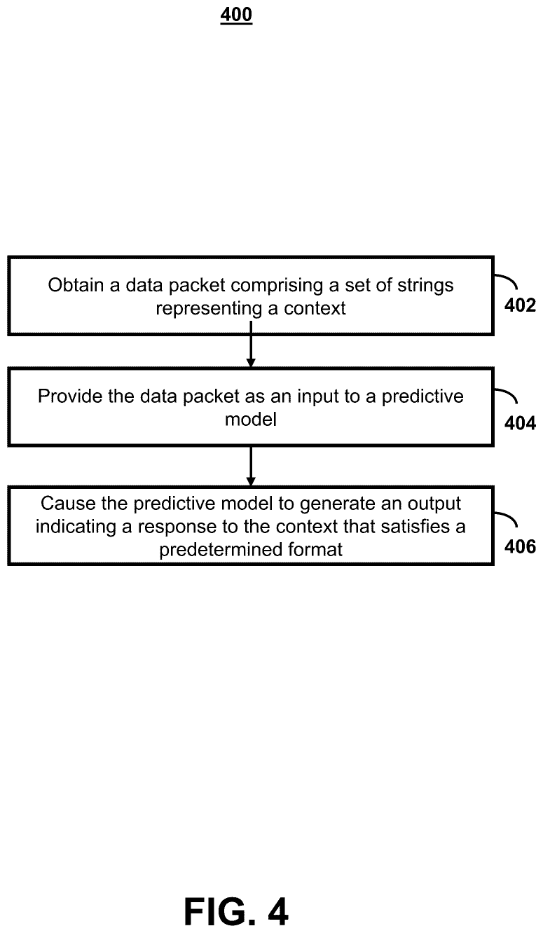

FIG. 4 shows a flowchart of the steps involved in a process 400 for configuring components of a protected network to limit format drift during execution of the components of the protected network, in accordance with one or more embodiments. For example, a system that is the same as (or similar to) the network monitor 102 of FIG. 1 (or one or more components thereof) can implement process 400.

At operation 402, the process 400 can include obtaining a data packet comprising a set of strings representing a context. The data packet may arrive over a TLS-protected channel from a client device (e.g., that is the same as, or similar to, the client devices 110 of FIG. 1). In these examples, the network monitor may first decrypt the payload using a session key retrieved from its secure key store. The network monitor may then timestamp the packet and assigns a session identifier that lets subsequent packets in the same workflow be correlated. The resulting set of strings can include any prompt (e.g., ranging from an algebraic word problem to a loan-risk inquiry) that can be analyzed by the predictive model (e.g., that is the same as, or similar to, the predictive model 106a of FIG. 1).

At operation 404, the process 400 can include providing the set of strings as an input to the predictive model. For example, the network operation processor can tokenize the set of string, appends positional metadata, and converts the token sequence into an embedding compatible with the predictive model. The network operation processor can choose the appropriate predictive model instance from a group of predictive models and input the embedding to the predictive model. This can cause the predictive model to generate an output in response to the input.

At operation 406, the process 400 can include causing the predictive model to generate an output indicating a response to the context that satisfies a predetermined format. During inference, the predictive model can produce an output. In some embodiments, the predictive model can be configured to produce this output based on training involving the use of a teacher model (e.g., that is the same as, or similar to, the teacher model 106b of FIG. 1). As described, the predictive model can be trained on target outputs that are conditioned so as to configure the predictive model to maintain a predetermined format associated with established bullet hierarchies, indentation levels, tab alignment, and variable-type annotations. As discussed, during training, if the outputs of the predictive model deviate from the predetermined format, the teacher model can generate a critique and corrected target output, allowing the network operation processor to compute a joint loss and fine-tune the predictive model and minimize or eliminate format drift. This configuration can continue for a number of epochs until the predictive model's performance indicates convergence.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Some or all of the systems described herein can be implemented by configuring one or more Application-Specific Integrated Circuit (ASICs). As described, an ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects that can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for configuring components of a protected network to limit format drift during execution of the components of the protected network and reduce susceptibility to malicious network activity.
2. The method of any one of the preceding embodiments, comprising: providing a set of strings representing a context as an input to a predictive model configured to perform one or more context-based operations and one or more analysis-based operations based on the set of strings; wherein the predictive model is trained by: obtaining target outputs and critiques based on outputs of the predictive model, the target outputs generated by a predetermined predictive model based on predetermined formats; and executing one or more configuration operations to reconfigure the predictive model based on the target outputs and the critiques to cause the predictive model to generate the outputs similar to the target outputs in the predetermined formats; and causing the predictive model to generate an output indicating a response to the context that satisfies a predetermined format associated with the context based on providing the set of strings as the input to the predictive model.
3. The method of any one of the preceding embodiments, further comprising: obtaining a data packet based on encryption of the data packet by a client device that is configured to generate a user interface; in response to obtaining the data packet, decrypting the data packet; and determining to provide the data packet as the input to the predictive model based on decrypting the data packet.
4. The method of any one of the preceding embodiments, wherein providing the set of strings as the input to the predictive model comprises: segmenting the set of strings into a plurality of tokens forming a token sequence that represents the context; and providing the plurality of tokens as the input to the predictive model to cause the predictive model to generate the output.
5. The method of any one of the preceding embodiments, wherein providing the plurality of tokens as the input to the predictive model comprises: generating an embedding corresponding to the plurality of tokens based on a mapping between the plurality of tokens and the token sequence; and determining to provide the embedding as the input to the predictive model based on generating the embedding.
6. The method of any one of the preceding embodiments, wherein obtaining the target outputs and the critiques comprises: obtaining the target outputs and the critiques based on the execution of the predetermined predictive model that, in response to obtaining the outputs of the predictive model, is configured to generate (i) the critiques identifying at least one deficiency in the outputs from the predictive model and (ii) the target outputs that are based on the critiques, the predetermined formats, and corresponding training inputs; and determining to execute the one or more configuration operations based on obtaining the target outputs and the critiques.
7. The method of any one of the preceding embodiments, wherein obtaining the critiques comprises: executing the predetermined predictive model based on data packets received as training inputs by the predictive model; and executing the predetermined predictive model based on the data packets received as the training inputs and the critiques to generate the target outputs.
8. The method of any one of the preceding embodiments, wherein executing the one or more configuration operations comprises: providing the data packets received as the training inputs to the predictive model to cause the predictive model to generate training outputs; and determining differences between the training outputs and the target outputs, wherein executing the one or more configuration operations comprises: executing the one or more configuration operations based on a joint loss function that applies penalties based on the differences between the training outputs and the target outputs while conditioning on the critiques as auxiliary inputs.
9. The method of any one of the preceding embodiments, further comprising: determining that a difference between the training outputs and the target outputs satisfies a difference threshold indicating convergence of the predictive model; and determining to forgo the execution of the one or more configuration operations based on determining that the difference between the training outputs and the target outputs satisfies the difference threshold.
10. The method of any one of the preceding embodiments, wherein determining the target outputs comprises: determining the target outputs based on executing the predetermined predictive model in accordance with a first sub-routine to cause the predetermined predictive model to: generate the critiques based on training inputs and the target outputs, and a second sub-routine to cause the predetermined predictive model to: generate the target outputs based on training outputs generated by the predictive model based on the training inputs and the critiques as conditioning information.
11. The method of any one of the preceding embodiments, wherein generating the target outputs comprises: generating conditioning inputs comprising the training outputs and the critiques; and providing the conditioning inputs to the predetermined predictive model to cause the predetermined predictive model to generate the target outputs.
12. The method of any one of the preceding embodiments, further comprising: providing training inputs comprising training data packets to the predictive model to cause the predictive model to generate training outputs having training formats that are at least in part different from the predetermined formats; and determining format differences between the training formats and the predetermined formats, wherein executing the one or more configuration operations comprises: executing the one or more configuration operations based on the format differences.
13. The method of any one of the preceding embodiments, further comprising: determining that at least one format difference from the format differences satisfies a format difference threshold indicating convergence of the predictive model; and determining to forgo the execution of the one or more configuration operations based on determining that the at least one format difference satisfies the format difference threshold.
14. The method of any one of the preceding embodiments, wherein the context corresponds to a mathematical query, wherein executing the one or more configuration operations comprises: causing the predictive model to generate training outputs based on training inputs corresponding to the target outputs, segmenting the training outputs into sets of sub-outputs to determine that the training outputs comprise (i) step-by-step derivations resulting in the training outputs, (ii) one or more symbolic equations expressed in mathematical markup, and (iii) a final numeric or algebraic solution, and determining to execute the one or more configuration operations based on differences between the sets of sub-outputs and the target outputs.
15. The method of any one of the preceding embodiments, further comprising: determining that portions of the training outputs are missing from the sets of sub-outputs; and determining to execute the one or more configuration operations based on the portions of the training outputs are missing from the sets of sub-outputs.
16. The method of any one of the preceding embodiments, further comprising: causing the predictive model to generate sets of intermediate outputs when generating the training outputs based on the training inputs corresponding to the target outputs, determining that one or more intermediate outputs from the sets of intermediate outputs are logically inconsistent, and determining to execute the one or more configuration operations based on determining that the one or more intermediate outputs are logically inconsistent.
17. One or more non-transitory, computer-readable mediums storing instructions recorded thereon that, when executed by a data processing apparatus, cause the data processing apparatus to perform operations comprising those of any of embodiments 1-16.
18. A system comprising one or more processors and memory storing instructions that, when executed by the processors, cause the processors to effectuate operations comprising those of any of embodiments 1-16.
19. A system comprising means for performing any of embodiments 1-16.

What is claimed is:

1. A system for configuring components of a protected network to limit format drifts during execution of the components of the protected network and reduce susceptibility to malicious network activity, the system comprising:
one or more processors; and
one or more non-transitory computer-readable mediums having instructions recorded thereon that, when executed by the one or more processors, cause the one or more processors to perform operations comprising:
obtaining a data packet comprising a set of strings representing a context as based on interactions involving a user interface;
providing the data packet as an input to a predictive model configured to perform one or more context-based operations and one or more analysis-based operations based on the data packet;
wherein the predictive model is trained by:
obtaining target outputs and critiques based on outputs of the predictive model, the target outputs generated by a predetermined predictive model based on predetermined formats; and
executing one or more configuration operations to reconfigure the predictive model based on the target outputs and the critiques to cause the predictive model to generate the outputs similar to the target outputs that are based on the predetermined formats and reduce a probability that the predictive model will incorporate a format drift into the outputs; and
causing the predictive model to generate an output indicating a response to the context that satisfies a predetermined format associated with the context based on providing the data packet as the input to the predictive model.

2. A method for configuring components of a protected network to limit format drift during execution of the components of the protected network and reduce susceptibility to malicious network activity, the method comprising:
providing a set of strings representing a context as an input to a predictive model configured to perform one or more context-based operations and one or more analysis-based operations based on the set of strings;
wherein the predictive model is trained by:
obtaining target outputs and critiques based on outputs of the predictive model, the target outputs generated by a predetermined predictive model based on predetermined formats; and
executing one or more configuration operations to reconfigure the predictive model based on the target outputs and the critiques to cause the predictive model to generate the outputs similar to the target outputs in the predetermined formats; and
causing the predictive model to generate an output indicating a response to the context that satisfies a predetermined format associated with the context based on providing the set of strings as the input to the predictive model.

3. The method of claim 2, further comprising:
obtaining a data packet based on encryption of the data packet by a client device that is configured to generate a user interface;
in response to obtaining the data packet, decrypting the data packet; and
determining to provide the data packet as the input to the predictive model based on decrypting the data packet.

4. The method of claim 2, wherein providing the set of strings as the input to the predictive model comprises:
segmenting the set of strings into a plurality of tokens forming a token sequence that represents the context; and
providing the plurality of tokens as the input to the predictive model to cause the predictive model to generate the output.

5. The method of claim 4, wherein providing the plurality of tokens as the input to the predictive model comprises:
generating an embedding corresponding to the plurality of tokens based on a mapping between the plurality of tokens and the token sequence; and
determining to provide the embedding as the input to the predictive model based on generating the embedding.

6. The method of claim 2, wherein obtaining the target outputs and the critiques comprises:
obtaining the target outputs and the critiques based on the execution of the predetermined predictive model that, in response to obtaining the outputs of the predictive model, is configured to generate (i) the critiques identifying at least one deficiency in the outputs from the predictive model and (ii) the target outputs that are based on the critiques, the predetermined formats, and corresponding training inputs; and
determining to execute the one or more configuration operations based on obtaining the target outputs and the critiques.

7. The method of claim 6, wherein obtaining the critiques comprises:
executing the predetermined predictive model based on data packets received as training inputs by the predictive model; and
executing the predetermined predictive model based on the data packets received as the training inputs and the critiques to generate the target outputs.

8. The method of claim 7, wherein executing the one or more configuration operations comprises:
providing the data packets received as the training inputs to the predictive model to cause the predictive model to generate training outputs; and
determining differences between the training outputs and the target outputs,
wherein executing the one or more configuration operations comprises:
executing the one or more configuration operations based on a joint loss function that applies penalties based on the differences between the training outputs and the target outputs while conditioning on the critiques as auxiliary inputs.

9. The method of claim 8, further comprising:
determining that a difference between the training outputs and the target outputs satisfies a difference threshold indicating convergence of the predictive model; and
determining to forgo the execution of the one or more configuration operations based on determining that the difference between the training outputs and the target outputs satisfies the difference threshold.

10. The method of claim 6, wherein determining the target outputs comprises:
determining the target outputs based on executing the predetermined predictive model in accordance with a first sub-routine to cause the predetermined predictive model to:
generate the critiques based on training inputs and the target outputs, and
a second sub-routine to cause the predetermined predictive model to:
generate the target outputs based on training outputs generated by the predictive model based on the training inputs and the critiques as conditioning information.

11. The method of claim 10, wherein generating the target outputs comprises:
generating conditioning inputs comprising the training outputs and the critiques; and
providing the conditioning inputs to the predetermined predictive model to cause the predetermined predictive model to generate the target outputs.

12. The method of claim 2, further comprising:
providing training inputs comprising training data packets to the predictive model to cause the predictive model to generate training outputs having training formats that are at least in part different from the predetermined formats; and
determining format differences between the training formats and the predetermined formats,
wherein executing the one or more configuration operations comprises:
executing the one or more configuration operations based on the format differences.

13. The method of claim 12, further comprising:
determining that at least one format difference from the format differences satisfies a format difference threshold indicating convergence of the predictive model; and
determining to forgo the execution of the one or more configuration operations based on determining that the at least one format difference satisfies the format difference threshold.

14. The method of claim 2, wherein the context corresponds to a mathematical query,
wherein executing the one or more configuration operations comprises:
causing the predictive model to generate training outputs based on training inputs corresponding to the target outputs,
segmenting the training outputs into sets of sub-outputs to determine that the training outputs comprise (i) step-by-step derivations resulting in the training outputs, (ii) one or more symbolic equations expressed in mathematical markup, and (iii) a final numeric or algebraic solution, and
determining to execute the one or more configuration operations based on differences between the sets of sub-outputs and the target outputs.

15. The method of claim 14, further comprising:
determining that portions of the training outputs are missing from the sets of sub-outputs; and
determining to execute the one or more configuration operations based on the portions of the training outputs are missing from the sets of sub-outputs.

16. The method of claim 14, further comprising:
causing the predictive model to generate sets of intermediate outputs when generating the training outputs based on the training inputs corresponding to the target outputs,
determining that one or more intermediate outputs from the sets of intermediate outputs are logically inconsistent, and
determining to execute the one or more configuration operations based on determining that the one or more intermediate outputs are logically inconsistent.

17. One or more non-transitory computer-readable mediums storing instructions thereon that, when executed by one or more processors, cause the one or more processors to:
obtaining a set of strings representing a context as based on interactions involving a user interface;
providing the set of strings as an input to a predictive model configured to perform one or more context-based operations and one or more analysis-based operations based on the set of strings;
wherein the predictive model is trained by:
obtaining target outputs and critiques based on outputs of the predictive model, the target outputs generated by a predetermined predictive model based on predetermined formats; and
executing one or more configuration operations to reconfigure the predictive model based on the target outputs and the critiques to cause the predictive model to generate the outputs similar to the target outputs in the predetermined formats; and
causing the predictive model to generate an output indicating a response to the context that satisfies a predetermined format associated with the context based on providing the set of strings as the input to the predictive model.

18. The one or more non-transitory computer-readable mediums of claim 17, wherein the instructions further cause the one or more processors to:
obtain a data packet based on encryption of the data packet by a client device that is configured to generate the user interface;
in response to obtaining the data packet, decrypt the data packet to obtain the set of strings; and
determine to provide the data packet as the input to the predictive model based on decrypting the data packet.

19. The one or more non-transitory computer-readable mediums of claim 17, wherein the instructions that cause the one or more processors to provide the set of strings as the input to the predictive model cause the one or more processors to:
segment the set of strings into a plurality of tokens forming a token sequence that represents the context; and
provide the plurality of tokens as the input to the predictive model to cause the predictive model to generate the output.

20. The one or more non-transitory computer-readable mediums of claim 19, wherein the instructions that cause the one or more processors to provide the plurality of tokens as the input to the predictive model cause the one or more processors to:
generate an embedding corresponding to the plurality of tokens based on a mapping between the plurality of tokens and the token sequence; and
determine to provide the embedding as the input to the predictive model based on generating the embedding.
